(19) United States
(12) Patent Application Publication
(10) Pub. No.: US 2026/0055939 A1
(43) Pub. Date: Feb. 26, 2026

(54) SENSOR-INTEGRATED EXPANSION VALVE

(71) Applicant: Hanon Systems, Daejeon (KR)

(72) Inventors: Chang Hyun BAEK, Daejeon (KR); Sang Ho OH, Daejeon (KR); Young Chul KIM, Daejeon (KR); Chae Geun LIM, Daejeon (KR); Yun Sung JO, Daejeon (KR)

(73) Assignee: Hanon Systems, Daejeon (KR)

(21) Appl. No.: 19/099,692

(22) PCT Filed: Sep. 20, 2023
(86) PCT No.: PCT/KR2023/014212

§ 371 Date: Jan. 29, 2025

(30) Foreign Application Priority Data
Dec. 27, 2022 (KR) 10-2022-0185214

(51) Int. Cl. F25B 41/31

(52) U.S. Cl. CPC F25B 41/31; F25B 2341/0683; F25B 2500/221

(57) ABSTRACT

A sensor-integrated expansion valve includes: a PT sensor installed in a sensor hole of a valve body to detect pressure and temperature of refrigerant in a refrigerant flow path, the PT sensor including a sensor body assembled to the valve body portion around the sensor hole, a sensing rod inserted from the sensor body into the sensor hole and having an end portion exposed into the refrigerant flow path, and a sensor circuit board configured to process data on the pressure and the temperature of the refrigerant detected by the sensing rod and transmit the data to a main circuit board of the on the valve body; a thread fastening assembly part configured to threadedly fasten and remove the PT sensor to and from the sensor hole of the valve body; and an electrical connection part configured to constantly electrically connect the sensor circuit board to the main circuit board.

### TECHNICAL FIELD

The present invention relates to a sensor-integrated expansion valve, and more particularly, a sensor-integrated expansion valve in which the assembly structure of a PT sensor to a sensor hole of a valve body is improved to thereby prevent the leakage of refrigerant from a refrigerant flow path through the sensor hole and consequently prevent the corrosion and damage to a sensor circuit board of the PT sensor and a main circuit board and the electrical short-circuiting due to refrigerant leakage to the sensor hole side.

### BACKGROUND ART

A vehicular air conditioner is equipped with various fluid control valves and sensors. For example, the vehicular air conditioner includes an expansion valve that depressurizes and expands refrigerant, and a PT sensor that detects pressure and temperature of refrigerant.

As shown in FIG. 1, the expansion valve 1 is installed on the inlet side of an evaporator 3 to reduce the pressure of the refrigerant introduced into the evaporator 3.

The PT sensor 5 is installed on the outlet side of the evaporator 3 to detect the temperature and pressure of the refrigerant discharged from the evaporator 3.

Meanwhile, the expansion valve 1 and the PT sensor 5 are installed at the inlet and outlet sides of the evaporator 3, respectively, and are configured as a set together with the evaporator 3. Therefore, it is necessary to configure them as one unit for the sake of convenience during assembly and for the sake of post-assembly management and cost reduction.

In particular, since the refrigerant discharged from the evaporator 3 usually passes through a refrigerant path (not shown) on the low pressure side of the expansion valve 1, the PT sensor 5 that detects the temperature and pressure of the refrigerant on the outlet side of the evaporator 3 is structurally arranged very close to the expansion valve 1.

Therefore, in order to shorten the assembly time, improve the convenience of assembly, improve the post-assembly management, and reduce the costs, it is required to integrate the PT sensor 5 into the expansion valve 1.

### DETAILED DESCRIPTION OF THE INVENTION

### Technical Task

The present invention has been made to solve the above-mentioned problems of the prior art, and it is an object of the present invention to provide a sensor-integrated expansion valve that can make it possible to integrate a PT sensor into an expansion valve.

Another object of the present invention is to provide a sensor-integrated expansion valve that can prevent leakage of refrigerant from a refrigerant flow path through a sensor hole by integrating the PT sensor into the expansion valve and improving the assembly structure of the PT sensor with respect to the sensor hole of the expansion valve.

A further object of the present invention is to provide a sensor-integrated expansion valve that can prevent the corrosion and damage to a sensor circuit board of a PT sensor and a main circuit board and the electrical short-circuiting due to refrigerant leakage to a sensor hole by adopting the configuration that can prevent refrigerant leakage from the refrigerant flow path through the sensor hole.

A still further object of the present invention is to provide a sensor-integrated expansion valve that can prevent a phenomenon of insufficient refrigerant in an air conditioner due to the refrigerant leakage to the sensor hole and a phenomenon of reduced cooling performance of the air conditioner by adopting the configuration that can prevent leakage of the refrigerant from the refrigerant flow path through the sensor hole.

### Means to Solve the Task

In order to achieve these objects, the present invention provides a sensor-integrated expansion valve, including: a PT sensor installed in a sensor hole of a valve body to detect a pressure and a temperature of refrigerant in a refrigerant flow path, the PT sensor including a sensor body assembled to the valve body portion around the sensor hole, a sensing rod inserted from the sensor body into the sensor hole and having an end portion exposed into the refrigerant flow path, and a sensor circuit board configured to process data on the pressure and the temperature of the refrigerant detected by the sensing rod and transmit the data to a main circuit board of the on the valve body; a thread fastening assembly part configured to threadedly fasten and remove the PT sensor to and from the sensor hole of the valve body; and an electrical connection part configured to constantly electrically connect the sensor circuit board whose position is changed about a thread fastening rotation center axis of the PT sensor depending on the degree of thread fastening of the PT sensor into the sensor hole, to the main circuit board.

The thread fastening assembly part may include a female thread portion formed inside the sensor hole, and a male thread portion formed on an outer circumference surface of the sensing rod of the PT sensor so as to be threadedly fastened to the female thread portion of the sensor hole.

The electrical connection part may include one or more sensor-side terminals protruding from the sensor circuit board of the PT sensor toward the main circuit board above the of the sensor body, and one or more valve body-side terminals formed on the main circuit board of the valve body so as to be electrically connected to the sensor-side terminals, and the valve body-side terminals may be configured to be constantly connected to the sensor-side terminals whose positions are changed about the thread fastening rotation center axis of the PT sensor depending on the degree of thread fastening of the PT sensor into the sensor hole.

The sensor-side terminals may protrude from the sensor circuit board toward the main circuit board above the sensor body, and may be arranged radially at certain intervals in a radial outward direction about the thread fastening rotation center axis of the sensor body relative to the sensor hole, the valve body-side terminals may be formed on the main circuit board of the valve body so that the valve body-side terminals can be electrically connected to the sensor-side terminals, and the valve body-side terminals may have a pattern such that the valve body-side terminals can be constantly connected to the sensor-side terminals whose positions are changed about the thread fastening rotation center axis of the PT sensor depending on the degree of thread fastening of the PT sensor into the sensor hole.

The valve body-side terminals may have a pattern of a rotation trajectory identical to the rotation trajectory of each of the sensor-side terminals of the PT sensor that rotates about the thread fastening rotation center axis, and the valve body-side terminals may be configured to respond to changes in final positions of the sensor-side terminals that varies depending on the thread fastening degree of the PT sensor during a thread fastening process of the PT sensor into the sensor hole.

The sensor-side terminals may be composed of elastic contact terminals of a pogo pin type, and may be constantly in elastic contact with the valve body-side terminals.

The sensor-integrated expansion valve may further include: a rubber O-ring arranged between the sensor body around the sensing rod and the valve body around the sensor hole while installed around the sensing rod of the PT sensor, wherein when the PT sensor is threadedly fastened into the sensor hole, the O-ring may be compressed between the sensor body around the sensing rod and the valve body around the sensor hole to hermetically seal a gap between the sensor body and the valve body.

### EFFECT OF THE INVENTION

According to the sensor-integrated expansion valve of the present invention, the PT sensor is integrated into the valve body of the expansion valve, and is threadedly fastened to the sensor hole of the valve body. This makes it possible to strengthen the fastening force of the PT sensor to the sensor hole of the valve body.

In addition, since the fastening force of the PT sensor to the sensor hole of the valve body can be strengthened, the sealing force of the O-ring between the valve body on the sensor hole side and the sensor body of the PT sensor can be increased through the strengthened fastening force.

In addition, since the sealing force of the O-ring between the valve body on the sensor hole side and the sensor body of the PT sensor can be increased, the phenomenon of refrigerant leakage from the refrigerant flow path through the sensor hole can be fundamentally prevented.

In addition, since the refrigerant leakage from the refrigerant flow path through the sensor hole can be prevented, it is possible to prevent the corrosion and damage to the sensor circuit board of the PT sensor and main circuit board and the electrical short-circuiting due to the refrigerant leakage to the sensor hole.

In addition, since the refrigerant leakage from the refrigerant flow path through the sensor hole can be prevented, it is possible to prevent a phenomenon of insufficient refrigerant in the air conditioner due to the refrigerant leakage to the sensor hole and a phenomenon of reduced cooling performance of the air conditioner.

In addition, since the sensor-side terminals of the PT sensor are configured as elastic contact terminals of a pogo pin type, and the valve body-side terminals that come into contact with the sensor-side terminals are structured to follow the rotation trajectory of the sensor-side terminals of the PT sensor that rotate about the thread fastening rotation center axis, the sensor-side terminals and the valve body-side terminals can be constantly connected regardless of the changes in the positions of the sensor-side terminals that occur during the thread fastening process of the PT sensor to the sensor hole.

Since the sensor-side terminals and the valve body-side terminals can be constantly connected regardless of the changes in the positions of the sensor-side terminals that occur during the thread fastening process of the PT sensor, the sensor-side terminals of the PT sensor and the valve body-side terminals of the valve body can be easily connected without any separate manual work, thereby improving the convenience of assembling the PT sensor.

### BRIEF DESCRIPTION OF THE DRAWINGS

FIG. 1 is a perspective view showing an expansion valve and a PT sensor of the prior art.

FIG. 2 is a sectional view showing the configuration of a sensor-integrated expansion valve according to the present invention.

FIG. 3 is an enlarged sectional view specifically showing the assembly portion of a PT sensor that constitutes the sensor-integrated expansion valve of the present invention.

FIG. 4 is an exploded perspective view specifically showing the assembly portion of the PT sensor that constitutes the sensor-integrated expansion valve of the present invention.

### BEST MODE TO IMPLEMENT THE INVENTION

Hereinafter, a preferred embodiment of a sensor-integrated expansion valve according to the present invention will be described in detail with reference to the accompanying drawings. The same components as those of the above-described prior art will be designated by the same reference numerals.

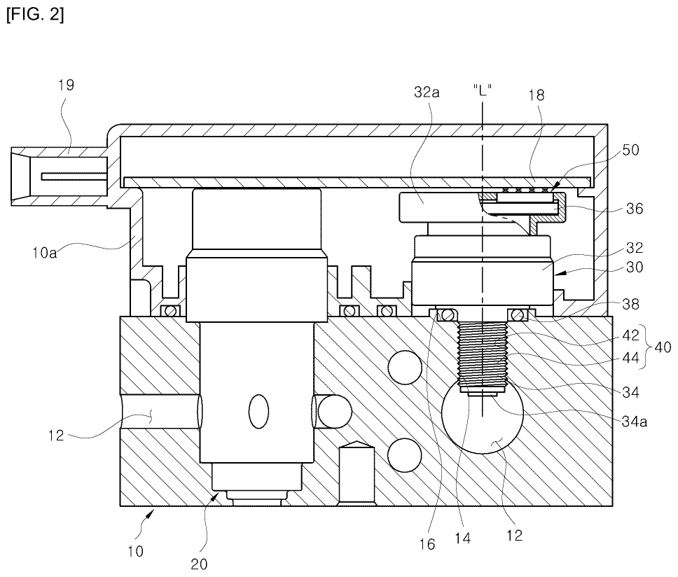

First, prior to describing the features of the sensor-integrated expansion valve according to the present invention, the general aspect of the sensor-integrated expansion valve will be briefly described with reference to FIG. 2.

The sensor-integrated expansion valve includes a valve body 10, and the valve body 10 includes a refrigerant flow path 12, an expansion valve 20 installed on the refrigerant flow path 12, and a PT sensor 30.

The PT sensor 30 is installed in a sensor hole 14 of the valve body 10, and includes a sensor body 32 assembled in a sensor assembly portion 16 around the sensor hole 14, a sensing rod 34 extending from the sensor body 32 and fitted into the sensor hole 14, the sensing rod 34 having a sensing part 34a provided at the end thereof to protrude into the refrigerant flow path 12, and a sensor circuit board 36 configured to process data on the pressure and temperature of the refrigerant detected by the sensing rod 34.

The sensor circuit board 36 is built into a head portion 32a of the sensor body 32 and is electrically connected to a main circuit board 18 on the valve body 10 side installed on the upper side.

The sensor circuit board 36 connected in this way transmits the data on the pressure and temperature of the refrigerant detected by the sensing rod 34 to the main circuit board 18, and allows the transmitted data on the pressure and temperature of the refrigerant to be transmitted again to an air conditioning control part (not shown) through an electrical connector 19.

Meanwhile, a rubber O-ring 38 is installed around the sensing rod 34 of the PT sensor 30.

The O-ring 38 is arranged between the sensor body 32 around the sensing rod 34 and the sensor assembly portion 16 around the sensor hole 14 when the sensing rod 34 is inserted into the sensor hole 14 and then assembled into the sensor assembly portion 16.

The O-ring 38 hermetically seals the space between the sensor hole 14 of the valve body 10 and the sensor body 32 of the PT sensor 30. Accordingly, the O-ring 38 prevents the refrigerant in the refrigerant flow path 12 from leaking to the outside through the sensor hole 14.

Next, the features of the sensor-integrated expansion valve according to the present invention will be described in detail with reference to FIGS. 2 to 4.

The sensor-integrated expansion valve of the present invention includes a thread fastening assembly part 40 that can threadedly fasten and remove the PT sensor 30 to and from the sensor hole 14 of the valve body 10.

The thread fastening assembly part 40 includes a female thread portion 42 formed inside the sensor hole 14, and a male thread portion 44 formed on the outer circumference surface of the sensing rod 34 of the PT sensor 30 so as to be threadedly fastened to the female thread portion 42 of the sensor hole 14.

The male thread portion 44 of the sensing rod 34 and the female thread portion 42 of the sensor hole 14 enable the sensing rod 34 of the PT sensor 30 to be threadedly assembled into the sensor hole 14 of the valve body 10.

Therefore, it is possible to strengthen the fastening force of the PT sensor 30 to the sensor hole 14 of the valve body 10. In particular, the fastening force of the PT sensor 30 to the sensor hole 14 of the valve body 10 is strengthened to a certain level or higher.

As a result, the fastening force of the PT sensor 30 to the sensor hole 14 is strengthened, and the sealing force of the O-ring 38 between the valve body 10 on the sensor hole 14 side and the sensor body 32 of the PT sensor 30 is increased through the strengthened fastening force.

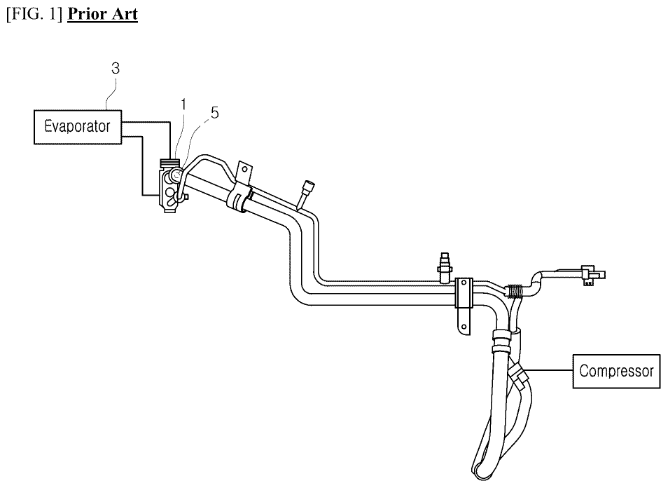

In particular, unlike the conventional O-ring that seals between the sensor hole 14 side and the PT sensor 30 by relying on the fastening force of the valve cover 10a to the valve body 10 (see FIG. 1), the O-ring 38 of the present invention seals the sensor hole 14 side and the PT sensor 30 side by being compressed by the thread fastening force between the male thread portion 44 of the sensing rod 34 and the female thread portion 42 of the sensor hole 14. This makes it possible to significantly increase the sealing force between the sensor hole 14 side and the PT sensor 30 side.

As a result, regardless of the fastening force of the valve cover 10a to the valve body 10, the sealing force between the sensor hole 14 side and the PT sensor 30 side can be maintained at a constant level.

Accordingly, even when the refrigerant pressure on the refrigerant flow path 12 side increases rapidly, the leakage of refrigerant from the refrigerant flow path 12 through the sensor hole 14 can be fundamentally prevented.

Meanwhile, since the leakage of refrigerant from the refrigerant flow path 12 through the sensor hole 14 can be prevented, it is possible to prevent the corrosion and damage to the sensor circuit board 36 of the PT sensor 30 and the main circuit board 18 and the electrical short-circuiting due to the leakage of refrigerant to the sensor hole 14.

In addition, since the leakage of refrigerant from the refrigerant flow path 12 through the sensor hole 14 can be prevented, it is possible to prevent a phenomenon of insufficient refrigerant in the air conditioner due to the refrigerant leakage to the sensor hole 14 and a phenomenon of reduced cooling performance of the air conditioner.

Referring again to FIGS. 2 to 4, the sensor-integrated expansion valve of the present invention includes an electrical connection part 50 for constantly electrically connecting the sensor circuit board 36 of the PT sensor 30 and the main circuit board 18 of the valve body 10.

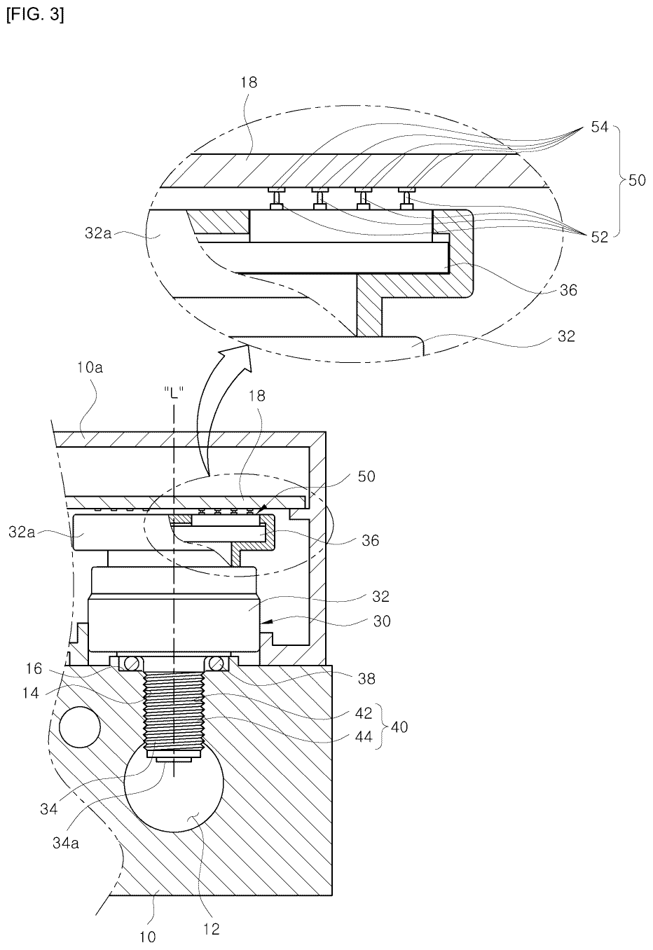

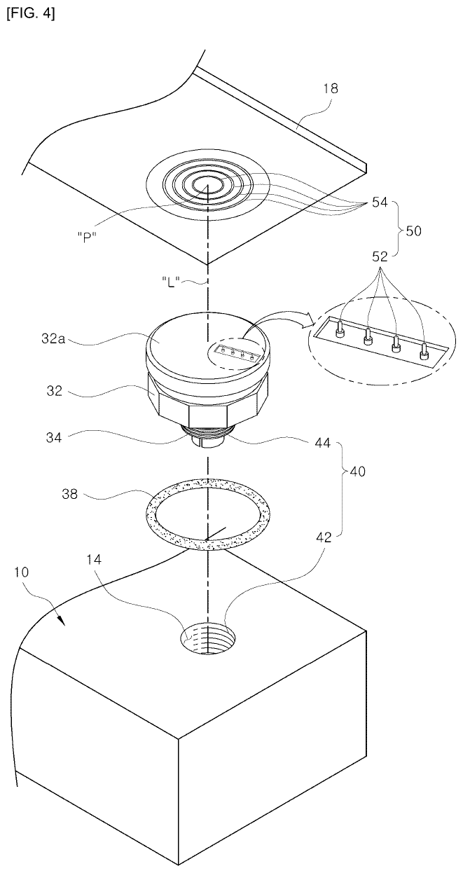

As shown in FIGS. 3 and 4, the electrical connection part 50 includes a plurality of sensor-side terminals 52 protruding from the sensor circuit board 36 of the PT sensor 30 toward the main circuit board 18 above the head portion 32a of the sensor body 32, and a plurality of valve body-side terminals 54 formed on the lower surface of the main circuit board 18 of the valve body 10 so as to be in contact with the plurality of sensor-side terminals 52.

The plurality of sensor-side terminals 52 protrude from the sensor circuit board 36 toward the main circuit board 18 above the head portion 32a of the sensor body 32, and are arranged radially at certain intervals in the radial outward direction about the thread fastening rotation center axis L of the sensor body 32 relative to the sensor hole 14, as shown in FIG. 4.

Here, it is preferable that each of the sensor-side terminals 52 be configured as an elastic contact terminal of a pogo pin type.

This is to ensure that the sensor-side terminals 52 are always in elastic contact with the valve body-side terminals 54.

In particular, during the thread fastening assembly process of the PT sensor 30 to the sensor hole 14, the height of the head portion 32a of the sensor body 32 of the PT sensor 30 is slightly changed depending on the strength and degree of the thread fastening of the PT sensor 30. Regardless of this slight change in the height of the head portion 32a, the sensor-side terminals 52 of the head portion 32a are always elastically in close contact with the valve body-side terminals 54 and are electrically connected to the valve body-side terminals 54.

The plurality of valve body-side terminals 54 are installed in the portion corresponding to the sensor-side terminals 52 of the PT sensor 30 on the lower surface of the main circuit board 18.

The valve body-side terminals 54 are electrically connected to the sensor-side terminals 52, respectively, to receive data on the pressure and temperature of the refrigerant detected by the PT sensor 30.

Meanwhile, as shown in FIG. 4, the valve body-side terminals 54 are formed with a circular pattern about the portion P corresponding to the thread fastening rotation center axis L of the PT sensor 30 among the portions of the main circuit board 18.

The valve body-side terminals 54 formed in this way have a pattern of a rotation trajectory identical to the rotation trajectory of the sensor-side terminals 52 of the PT sensor 30 that rotates about the thread fastening rotation center axis L when the PT sensor 30 is threadedly fastened to the sensor hole 14.

That is, the valve body-side terminals 54 are formed along the rotation trajectory of the sensor-side terminals 52 of the PT sensor 30 that rotates about the thread fastening rotation center axis L.

The valve body-side terminals 54 can respond to the changes in the final positions of the sensor-side terminals 52 that varies depending on the thread fastening strength and degree of the PT sensor 30 during the thread fastening process of the PT sensor 30 to the sensor hole 14.

In particular, by responding to changes in the final positions of the sensor-side terminals 52, the valve body-side terminals 54 can constantly make contact with the sensor-side terminals 52 regardless of the changes in the final positions of the sensor-side terminals 52.

Therefore, when threadedly fastening the PT sensor 30 into the sensor hole 14, the sensor-side terminals 52 of the PT sensor 30 and the valve body-side terminals 54 of the valve body 10 can be easily connected without any separate manual work.

As a result, it is possible to maximize the convenience of assembly of the PT sensor 30, which is assembled in a thread fastening manner into the sensor hole 14.

According to the sensor-integrated expansion valve of the present invention having such a configuration, the PT sensor 30 is integrated into the valve body 10 of the expansion valve, and is threadedly fastened to the sensor hole 14 of the valve body 10. This makes it possible to strengthen the fastening force of the PT sensor 30 to the sensor hole 14 of the valve body 10.

In addition, since the fastening force of the PT sensor 30 to the sensor hole 14 of the valve body 10 can be strengthened, the sealing force of the O-ring 38 between the valve body 10 on the sensor hole 14 side and the sensor body 32 of the PT sensor 30 can be increased through the strengthened fastening force.

In addition, since the sealing force of the O-ring 38 between the valve body 10 on the sensor hole 14 side and the sensor body 32 of the PT sensor 30 can be increased, the phenomenon of refrigerant leakage from the refrigerant flow path 12 through the sensor hole 14 can be fundamentally prevented.

In addition, since the refrigerant leakage from the refrigerant flow path 12 through the sensor hole 14 can be prevented, it is possible to prevent the corrosion and damage to the sensor circuit board 36 of the PT sensor 30 and main circuit board 18 and the electrical short-circuiting due to the refrigerant leakage to the sensor hole 14.

In addition, since the refrigerant leakage from the refrigerant flow path 12 through the sensor hole 14 can be prevented, it is possible to prevent a phenomenon of insufficient refrigerant in the air conditioner due to the refrigerant leakage to the sensor hole 14 and a phenomenon of reduced cooling performance of the air conditioner.

In addition, since the sensor-side terminals 52 of the PT sensor 30 are configured as elastic contact terminals of a pogo pin type, and the valve body-side terminals 54 that come into contact with the sensor-side terminals 52 are structured to follow the rotation trajectory of the sensor-side terminals of the PT sensor 30 that rotate about the thread fastening rotation center axis, the sensor-side terminals 52 and the valve body-side terminals 54 can be constantly connected regardless of the changes in the positions of the sensor-side terminals 52 that occur during the thread fastening process of the PT sensor 30 to the sensor hole 14.

Since the sensor-side terminals 52 and the valve body-side terminals 54 can be constantly connected regardless of the changes in the positions of the sensor-side terminals 52 that occur during the thread fastening process of the PT sensor 30, the sensor-side terminals 52 of the PT sensor 30 and the valve body-side terminals 54 of the valve body 30 can be easily connected without any separate manual work, thereby improving the convenience of assembling the PT sensor 30.

While the preferred embodiment of the present invention has been described above bay way of example, the scope of the present invention is not limited to such as specific embodiment, and may be appropriately changed within the scope recited in the claims.

1. A sensor-integrated expansion valve, comprising:
a PT sensor installed in a sensor hole of a valve body to detect pressure and temperature of refrigerant in a refrigerant flow path, the PT sensor including a sensor body assembled to the valve body portion around the sensor hole, a sensing rod inserted from the sensor body into the sensor hole and having an end portion exposed into the refrigerant flow path, and a sensor circuit board configured to process data on the pressure and the temperature of the refrigerant detected by the sensing rod and transmit the data to a main circuit board of the on the valve body;
a thread fastening assembly part configured to threadedly fasten and remove the PT sensor to and from the sensor hole of the valve body; and
an electrical connection part configured to constantly electrically connect the sensor circuit board whose position is changed about a thread fastening rotation center axis of the PT sensor depending on the degree of thread fastening of the PT sensor into the sensor hole, to the main circuit board.

2. The sensor-integrated expansion valve of claim 1, wherein the thread fastening assembly part includes a female thread portion formed inside the sensor hole, and a male thread portion formed on an outer circumference surface of the sensing rod of the PT sensor so as to be threadedly fastened to the female thread portion of the sensor hole.

3. The sensor-integrated expansion valve of claim 2, wherein the electrical connection part includes one or more sensor-side terminals protruding from the sensor circuit board of the PT sensor toward the main circuit board above the of the sensor body, and one or more valve body-side terminals formed on the main circuit board of the valve body so as to be electrically connected to the sensor-side terminals, and
the valve body-side terminals are configured to be constantly connected to the sensor-side terminals whose positions are changed about the thread fastening rotation center axis of the PT sensor depending on the degree of thread fastening of the PT sensor into the sensor hole.

4. The sensor-integrated expansion valve of claim 3, wherein the sensor-side terminals protrude from the sensor circuit board toward the main circuit board above the sensor body, and are arranged radially at certain intervals in a radial outward direction about the thread fastening rotation center axis of the sensor body relative to the sensor hole,
the valve body-side terminals are formed on the main circuit board of the valve body so that the valve body-side terminals can be electrically connected to the sensor-side terminals, and
the valve body-side terminals have a pattern such that the valve body-side terminals can be constantly connected to the sensor-side terminals whose positions are changed about the thread fastening rotation center axis of the PT sensor depending on the degree of thread fastening of the PT sensor into the sensor hole.

5. The sensor-integrated expansion valve of claim 4, wherein the valve body-side terminals have a pattern of a rotation trajectory identical to the rotation trajectory of each of the sensor-side terminals of the PT sensor that rotates about the thread fastening rotation center axis, and
the valve body-side terminals are configured to respond to changes in final positions of the sensor-side terminals that varies depending on the thread fastening degree of the PT sensor during a thread fastening process of the PT sensor into the sensor hole.

6. The sensor-integrated expansion valve of claim 5, wherein the sensor-side terminals are composed of elastic contact terminals of a pogo pin type, and are constantly in elastic contact with the valve body-side terminals.

7. The sensor-integrated expansion valve of claim 6, further comprising:
a rubber O-ring arranged between the sensor body around the sensing rod and the valve body around the sensor hole while installed around the sensing rod of the PT sensor,
wherein when the PT sensor is threadedly fastened into the sensor hole, the O-ring is compressed between the sensor body around the sensing rod and the valve body around the sensor hole to hermetically seal a gap between the sensor body and the valve body.

8. The sensor-integrated expansion valve of claim 1, wherein the sensor circuit board is built into a head portion of the sensor body and is electrically connected to a main circuit board on the valve body side installed on the upper side.

9. The sensor-integrated expansion valve of claim 8, wherein the sensor circuit board transmits the data on the pressure and temperature of the refrigerant detected by the sensing rod to the main circuit board, and allows the transmitted data on the pressure and temperature of the refrigerant to be transmitted again to an air conditioning control part through an electrical connector.

10. The sensor-integrated expansion valve of claim 5, wherein the plurality of valve body-side terminals are installed in the portion corresponding to the sensor-side terminals of the PT sensor on the lower surface of the main circuit board.

11. The sensor-integrated expansion valve of claim 10, wherein the valve body-side terminals are formed with a circular pattern about the portion corresponding to the thread fastening rotation center axis of the PT sensor among the portions of the main circuit board.

12. The sensor-integrated expansion valve of claim 7, wherein the O-ring is arranged between the sensor body around the sensing rod and the sensor assembly portion around the sensor hole when the sensing rod is inserted into the sensor hole and then assembled into the sensor assembly portion.
